(19) United States
(12) Patent Application Publication
(10) Pub. No.: US 2016/0148081 A1
(43) Pub. Date: May 26, 2016

(54) PRINTING APPARATUS, CONTROL METHOD IN PRINTING APPARATUS, AND STORAGE MEDIUM

(71) Applicant: CANON KABUSHIKI KAISHA, Tokyo (JP)

(72) Inventor: Shin Fukuda, Kawasaki-shi (JP)

(21) Appl. No.: 14/946,049

(22) Filed: Nov. 19, 2015

(30) Foreign Application Priority Data
Nov. 21, 2014 (JP) 2014-236996

(51) Int. Cl. G06K 15/12; H04N 1/23; G06K 15/02; H04N 1/00

(52) U.S. Cl. CPC G06K 15/12; H04N 1/0066; H04N 1/2323; H04N 1/2384; G06K 15/1868

(57) ABSTRACT

An amount of shift in a printing position detected by a sensor to adjust the printing position is reflected only on a sheet on which an image positioning operation is performed. A control method in a printing apparatus having a reading unit configured to read an image to generate image data includes printing, by a printing unit, an adjustment image for adjusting a printing position on a first sheet, obtaining an amount of shift in the printing position based on image data generated by the reading unit reading the adjustment image printed on the first sheet by the printing unit, and controlling the printing unit based on the obtained amount of shift in the printing position so that an image is printed on a second sheet of a type different from that of the first sheet.

### BACKGROUND OF THE INVENTION

1. Field of the Invention

The present invention relates to a printing apparatus for printing an image on a sheet, a control method in the printing apparatus, and a storage medium.

2. Description of the Related Art

There is a printing apparatus that can perform positioning of two-sided images when performing two-sided print processing, thereby correcting a printing position on the front and back. For example, such a printing apparatus prints two-sided images (hereinafter, referred to as marks) including two pages of sample image data, on the front and back of a sheet, and measures the printing position on each of the front and back of the printed sheet by using a sensor installed on a conveyance path of the sheet. The printing apparatus then detects amounts of shift in the printing position on the front and back from the result of the measurement, and corrects the printing position on the front and back of a subsequent sheet or sheets to be printed based on the detected amounts of shift (see Japanese Patent Application Laid-Open No. 2006-221609).

In the printing apparatus discussed in Japanese Patent Application Laid-Open No. 2006-221609, the amounts of shift in the printing position detected by the sensor to adjust the printing position are reflected only on the sheets of a type on which the image positioning operation is performed. For example, if the positioning operation of an image to be printed on “A4 plain paper (white paper)” is performed, the adjustment of the printing position based on the amounts of shift in the printing position detected by the sensor is reflected only on “A4 plain paper (white paper).” To adjust the printing position on “A4 plain paper (colored paper),” the image positioning operation needs to be separately performed on the “A4 plain paper (colored paper).” The user therefore needs to give an instruction for the image positioning operation sheet by sheet each time, which takes a lot of trouble.

### SUMMARY OF THE INVENTION

According to an aspect of the present invention, a printing apparatus includes a reading unit configured to read an image to generate image data, a printing unit configured to print an adjustment image for adjusting a printing position on a first sheet, an obtaining unit configured to obtain an amount of shift in the printing position based on image data generated by the reading unit reading the adjustment image printed on the first sheet by the printing unit, and a print controlling unit configured to control the printing unit based on the amount of shift in the printing position obtained by the obtaining unit so that an image is printed on a second sheet of a type different from that of the first sheet.

Further features of the present invention will become apparent from the following description of exemplary embodiments with reference to the attached drawings.

### BRIEF DESCRIPTION OF THE DRAWINGS

FIG. 1 is a block diagram illustrating a configuration of a printing system according to an exemplary embodiment.

FIG. 2 is an example of a sectional view illustrating a configuration of an image forming unit according to the present exemplary embodiment.

FIGS. 3A and 3B are an example of sectional views illustrating a configuration of a scanner unit according to the present exemplary embodiment.

FIG. 4 is an example of a table according to the present exemplary embodiment.

FIGS. 5A and 5B are diagrams for describing a configuration of screens according to the present exemplary embodiment.

FIG. 6 is an example of a schematic diagram illustrating an adjustment chart according to the present exemplary embodiment.

FIG. 7 is an example of a table according to the present exemplary embodiment.

FIGS. 8A and 8B are flowcharts for describing a control example according to a first exemplary embodiment.

FIG. 9 is a diagram for describing a configuration of a screen according to the first exemplary embodiment.

FIGS. 10A and 10B are diagrams for describing a configuration of screens according to the first exemplary embodiment.

FIG. 11 is a diagram for describing a configuration of a screen according to the first exemplary embodiment.

FIG. 12 is a diagram for describing a configuration of a screen according to the first exemplary embodiment.

FIGS. 13A and 13B are flowcharts for describing a control example according to a second exemplary embodiment.

FIG. 14 is a diagram for describing a configuration of a screen according to the second exemplary embodiment.

### DESCRIPTION OF THE EMBODIMENTS

Exemplary embodiments of the present invention will be described in detail below with reference to the accompanying drawings. It should be appreciated that the following exemplary embodiments are not intended to limit the present invention set forth in the claims, and all combinations of the features described in the exemplary embodiments are not necessarily indispensable to the solving means of the present invention.

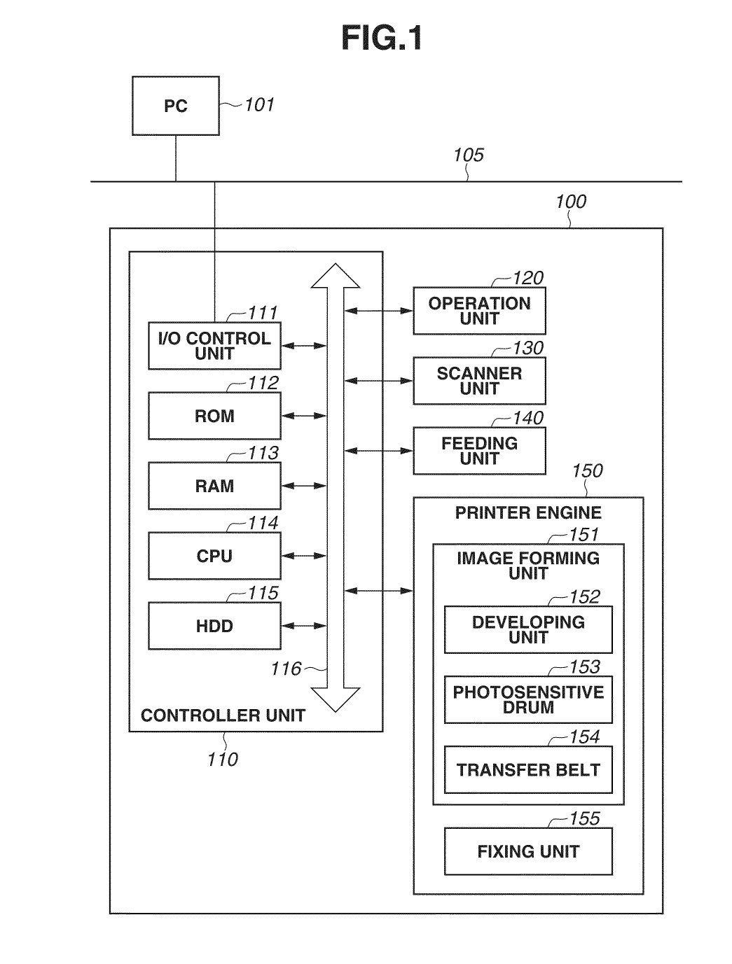

A configuration of a printing system according to a first exemplary embodiment of the present invention will be described with reference to FIG. 1.

In the first exemplary embodiment, for example, when adjusting a shift in the printing position with respect to colored paper, a central processing unit (CPU) 114 instructs an image forming unit 151 to print an adjustment chart on an alternative sheet (for example, white paper) based on attribute information about the colored paper. The CPU 114 then instructs a scanner unit 130 to scan the adjustment chart. The CPU 1114 then calculates an amount of shift in the printing position with respect to the alternative sheet based on scan image data on the adjustment chart printed on the alternative sheet, and registers the amount of shift in the printing position as that with respect to the colored paper.

A detailed description will be given below.

The printing system according to the present exemplary embodiment includes a printing apparatus 100 and a personal computer (PC) (computer) 101 which is an example of an external apparatus.

The printing apparatus 100 includes an image reading function for reading a document to generate image data, and a print function (copy function) for printing an image on a sheet based on the generated image data. The printing apparatus 100 also includes a print function (PC print function) for receiving a print job from the PC 101 and printing characters and/or images on a sheet based on data for which a print instruction is received. The print functions may implement either color or monochrome printing.

A controller unit (control unit) 110 of the printing apparatus 100 is connected to the PC 101 via a network cable 105. The controller unit 110 and the PC 101 are not limited to the configuration of being connected via the network cable 105. The controller unit 110 and the PC 101 may be configured to be connected via a local area network (LAN). The controller unit 110 and the PC 101 may be configured to be connected via a wide area network (WAN) such as the Internet, or via a dedicated printer cable. FIG. 1 illustrates an example of a configuration where one PC 101 is connected to the printing apparatus 100 via the network cable 105. However, this is not restrictive. A plurality of PCs 101 may be configured to be connected to the printing apparatus 100 via the network cable 105.

For example, the PC 101 generates image data by application software, and transmits the generated image data to the printing apparatus 100. The PC 101 also generates page description language (PDL) data, for example, by using application software and/or a printer driver. The controller unit 110 rasterizes the PDL data transmitted from the PC 101 via the network cable 105 to generate bitmap data. A program that performs the rasterizing operation is stored in a read-only memory (ROM) 112 or a hard disk drive (HDD) 115 to be described below.

In the present exemplary embodiment, the PC 101 is described as an example of the external apparatus. However, this is not restrictive. The external apparatus may be a portable information terminal such as a personal digital assistant (PDA) or a smartphone, a network-connected device, or an external dedicated apparatus.

Next, a block diagram of the printing apparatus 100 according to the present exemplary embodiment will be described with reference to FIG. 1. The printing apparatus 100 includes the controller unit 110, a printer engine 150 which is an image output device, the scanner unit 130 which is an image input device, a feeding unit 140, and an operation unit 120. Such units are electrically connected, and transmit and receive control commands and data to/from each other.

The controller unit 110 controls comprehensively an operation of the printing apparatus 100, and performs input/output control on image information and device information. The controller unit 110 includes the CPU 114, an input/output (I/O) control unit 111, the ROM 112, a random access memory (RAM) 113, and the HDD 115 as a plurality of functional blocks. Such modules are connected to each other via a system bus 116.

The CPU 114 is a processor which controls the entire printing apparatus 100. The CPU 114 controls comprehensively access with various connected devices based on a control program stored in the ROM 112. The CPU 114 also controls comprehensively various types of processing performed in the controller unit 110.

The I/O control unit 111 is a module for performing communication control with an external network.

The RAM 113 is a readable, writable memory. The RAM 113 also serves as a system work memory for the CPU 114 to operate with. The RAM 113 stores image data input from the scanner unit 130 and the PC 101, various programs, and setting information.

The ROM 112 is a read-only memory. The ROM 112 is a boot ROM. A boot program of the printing system is stored in the ROM 112 in advance.

The HDD 115 mainly stores information (system software) needed to activate and operate the computer 100 and image data.

If the controller unit 110 includes a nonvolatile RAM (NVRAM) (not illustrated), the system software, image data, and setting information received via the operation unit 120 to be described below may be stored in the NVRAM.

The RAM 113 or the HDD 115 stores a sheet management table 400 for managing attribute information about sheets used for printing in the printing apparatus 100 in a list form. Details of the sheet management table 400 will be described below with reference to FIG. 4.

The ROM 112 or the HDD 115 stores various control programs to be executed by the CPU 114, the control programs being needed to perform various types of processing of a flowchart to be described below. The ROM 112 or the HDD 115 also stores a display control program for causing a display unit (not illustrated) of the operation unit 120 including a user interface screen (hereinafter, UI screen) to display various UI screens. The CPU 114 reads the programs stored in the ROM 112 or the HDD 115 and loads the programs into the RAM 113 to perform various operations according to the present exemplary embodiment.

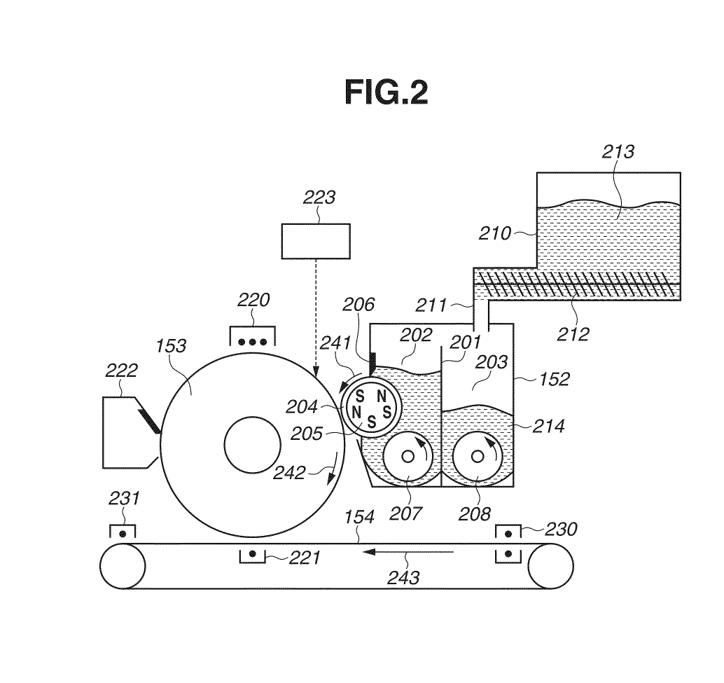

The printer engine 150 includes the image forming unit 151 and a fixing unit 155. The image forming unit 151 includes a developing unit 152, a photosensitive drum 153, and a transfer belt 154. Details of the image forming unit 151 and the fixing unit 155 will be described below with reference to FIG. 2.

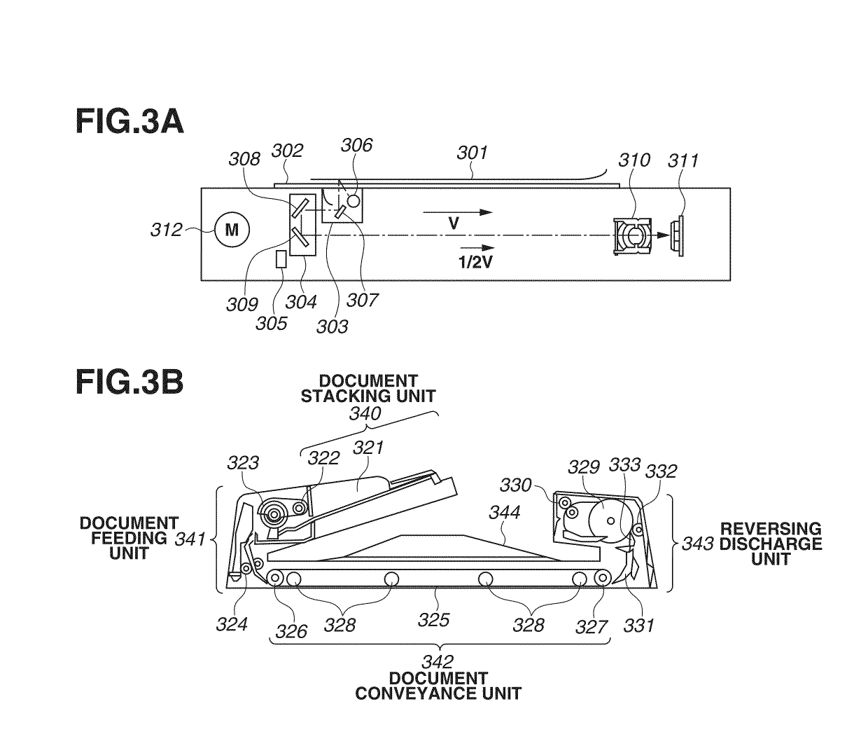

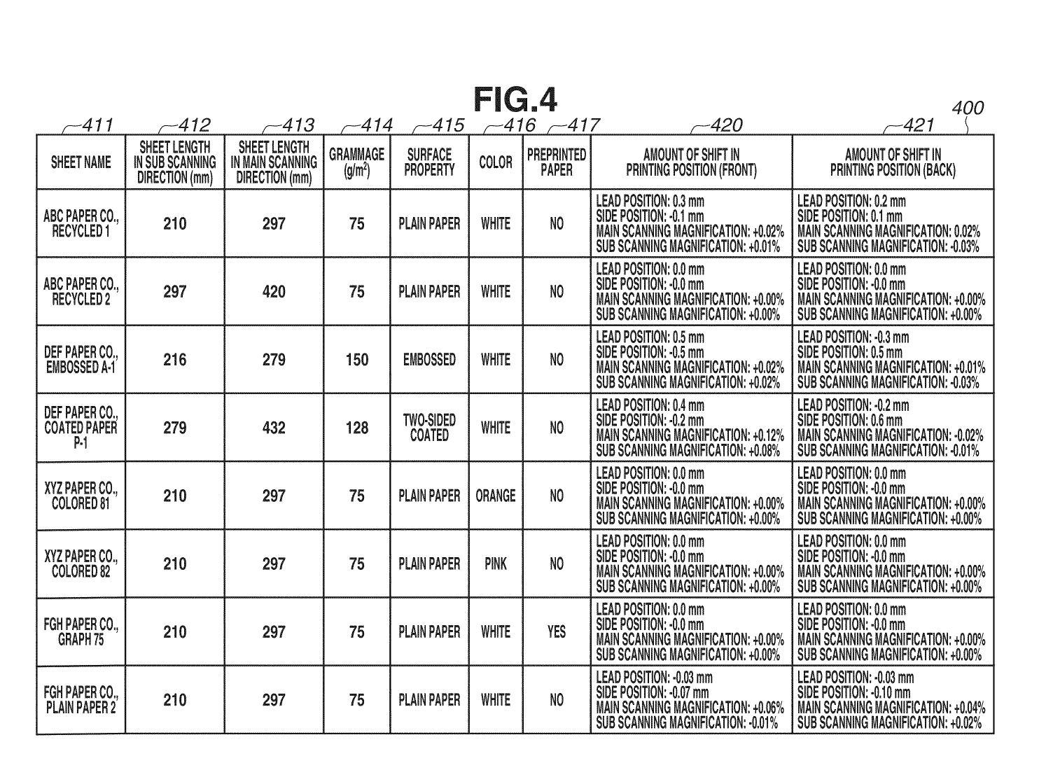

The scanner unit 130 scans an image on a document (sheet) by using an optical sensor to obtain scan image data. Details of the scanner unit 130 will be described below with reference to FIG. 3.

The feeding unit 140 is a unit for feeding sheets from a plurality of sheet holding units (such as a sheet feeding cassette, a sheet feeding deck, and a manual tray). Each sheet holding unit can hold a plurality of types of sheets and can hold a plurality of sheets. The sheets held in the sheet holding unit are separated one by one from the top and conveyed to the image forming unit 151. The image forming unit 151 prints an image on the sheet fed from the sheet holding unit based on image data input from the scanner unit 130 or the PC 101.

The operation unit 120 corresponds to an example of a user interface unit. The operation unit 120 includes the display unit (not illustrated) and a key input unit (not illustrated). The operation unit 120 has a function for receiving various settings from the user via the display unit and the key input unit. The operation unit 120 also has a function for providing information to the user via the display unit.

The display unit includes a liquid crystal display (LCD) (liquid crystal display unit) and a touch panel sheet including transparent electrodes (may be of electrostatic capacity type) pasted onto the LCD. The LCD displays an operation screen as well as a state of the printing apparatus 100. The key input unit includes, for example, a start key which is used to instruct a start of execution of scanning or copy, and a stop key which is used to instruct a stop of an operation in action such as scanning and copy.

Next, an example of a sectional view illustrating a configuration of the image forming unit 151 will be described with reference to FIG. 2.

The image forming unit 151 forms a toner image on the periphery of the photosensitive drum 153 by using the developing unit 152 according to image data generated by the controller unit 110.

The developing unit 152 is arranged to be opposed to the photosensitive drum 153. An interior of the developing unit 152 is divided into a developing section 202 and an agitation section 203 by a partition wall 201 which extends in a vertical direction.

A nonmagnetic developing sleeve 204 rotating in the direction of the arrow 241 is arranged in the developing section 202. A magnet 205 is fixed to and arranged inside the developing sleeve 204.

The developing sleeve 204 conveys a developer (for example, a two-component developer, including a magnetic carrier and nonmagnetic toner) taken out by a blade 206. The developing sleeve 204 supplies the developer to the photosensitive drum 153 in a developing area opposed to the photosensitive drum 153, whereby an electrostatic latent image on the photosensitive drum 153 is developed. To improve the developing efficiency, i.e., the rate of attachment of the toner to the electrostatic latent image, a developing bias voltage obtained by superposing a direct-current voltage on an alternating-current voltage is applied to the developing sleeve 204.

Screws 207 and 208 for agitating the developer are arranged in the developing section 202 and the agitation section 203, respectively. The screw 207 agitates the developer in the developing section 202 and conveys the agitated developer. The screw 208 agitates toner 213 which is supplied from a toner discharge port 211 of a toner replenishment tank 210 by rotation of a conveyance screw 212, and a developer 214 which already exists in the developing unit 152. The screw 208 conveys the agitated developer to uniformize toner density.

The partition wall 201 has developer passages (not illustrated) for communicating the developing section 202 and the agitation section 203 with each other in near and far ends in FIG. 2. The developer of which the toner density has dropped due to toner consumption by developing, in the developing section 202 is moved into the agitation section 203 through one of the developer passages by conveyance force of the screws 207 and 208. The developer of which the toner density is restored in the agitation section 203 is moved into the developing section 202 through the other developer passage.

The photosensitive drum 153 is driven to rotate in the direction of the arrow 242. A primary charging unit 220, the developing unit 152, a transfer unit 221, and a drum cleaner 222 are arranged around the photosensitive drum 153 in order in the rotation direction of the photosensitive drum 153. The primary charging unit 220 uniformly charges the photosensitive drum 153. The transfer unit 221 is intended to transfer a developed visible toner image to a sheet.

An image exposure device 223 is arranged above the photosensitive drum 153. The image exposure device 223 includes a semiconductor laser, a polygon mirror, and a reflection mirror. The image exposure device 223 receives input of a digital pixel signal (video data) corresponding to an image converted into a digital signal by the controller unit 110, and emits a laser beam modulated according to the digital pixel signal.

The image exposure device 223 irradiates the photosensitive drum 153 with the laser beam to scan the photosensitive drum 153 in its generatrix direction between the primary charging unit 220 and the developing unit 152. A drum surface of the photosensitive drum 153 is thereby exposed to form an electrostatic latent image. The photosensitive drum 153 then rotates and the electrostatic latent image is developed into a visible toner image by the developing unit 152.

The transfer belt 154 for conveying a sheet in the direction of the arrow 243 is arranged under the photosensitive drum 153. The transfer belt 154 is stretched across a plurality of rollers.

A sheet fed from the feeding unit 140 is conveyed from the right side of the transfer belt 154. The sheet is then borne on the transfer belt 154 by the action of an attraction charging units 230 arranged to be opposed to each other with the transfer belt 154 therebetween, and conveyed to the left side of the transfer belt 154 (in the direction of the arrow 243). When the sheet passes between the photosensitive drum 153 and the transfer unit 221, the visible toner image developed on the photosensitive drum 153 is transferred to the sheet by the action of the transfer unit 221. The sheet to which the toner image is transferred is separated from the transfer belt 154 by a diselectrification charging unit 231, and conveyed to the fixing unit 155.

The sheet then passes between a pressure roller (not illustrated) and a heating roller (not illustrated) of the fixing unit 155, whereby the toner is melted and pressed. As a result, the toner image is fixed to the sheet. After the transfer of the toner to the sheet, toner remaining on the photosensitive drum 153 is removed by the drum cleaner 222.

Next, an example of sectional views illustrating a configuration of the scanner unit 130 will be described with reference to FIGS. 3A and 3B.

There are two methods for reading an image of a document 301, namely, a feed reading method and an optical system moving method. In the feed reading method, the document 301 is placed on a document stacking unit (also referred to as a document tray) 340. The document 301 is conveyed by an automatic document feeder (ADF) while the image on the document 301 is read in a fixed position of an optical system (referred to as ADF reading). In the optical system moving method, the document 301 is placed on a platen glass (document positioning plate) 302. The optical system is moved while reading the image on the document 301 in a fixed document position (referred to as pressing plate reading). The scanner unit 130 according to the present exemplary embodiment will be described to include both a configuration for scanning the document 301 by ADF reading and a configuration for scanning the document 301 by pressing plate reading. However, the present invention is not limited thereto. The scanner unit 130 may include at least either one of the configuration for scanning the document 301 by ADF reading and the configuration for scanning the document 301 by pressing plate reading.

An instruction to start a read operation (also referred to as a scan operation) of the image on the document 301 by the scanner unit 130 is given, for example, by the user pressing the start key for instructing a start of execution of scanning. Alternatively, an instruction to start the scan operation may be given, for example, by the user pressing a start button displayed on the display unit of the operation unit 120.

The case of reading the image on the document 301 by pressing plate reading will initially be described below with reference to FIG. 3A.

If an instruction to start the scan operation is given, to read the image on the document 301 placed on the platen glass 302, a motor 312 is driven to once return a first mirror unit 303 and a second mirror unit 304 to a position where a home position sensor 305 is. A document illumination lamp 306 is turned on to irradiate the document 301 with the light. Reflected light from the document 301 is reflected at a first mirror 307 in the first mirror unit 303, a second mirror 308 in the second mirror unit 304, and a third mirror 309 in the second mirror unit 304. The reflected light from the third mirror 309 passes through a lens 310 to form an image on a charge coupled device (CCD) sensor 311, and is input to the CCD sensor 311 as a light signal.

The second mirror unit 304 moves at a speed half the speed (V) of the first mirror unit 303, i.e., V/2. The entire surface of the document 301 is scanned in such a manner.

In the present exemplary embodiment, the scanner unit 130 is described to include a reduction optical system in which the reflected light from the document 301 forms an image on the CCD sensor 311. However, this is not restrictive. The scanner unit 130 may include an equal magnification optical system in which the reflected light from the document 301 forms an image on a contact image sensor (CIS).

Next, the case of reading the image on the document 301 by ADF reading will be described below with reference to FIG. 3B.

If a document (not illustrated) is detected to be set on the document stacking unit 340 by a document detection sensor (not illustrated) arranged between a pickup roller 322 and a feed roller 323, the scan operation of the document by ADF reading is started.

If an instruction to start the scan operation is received, a document feeding unit 341 initially separates the topmost sheet (document) of the document bundle by a friction separation method one by one, and conveys the separated document to a registration roller pair 324. To feed the document, the pickup roller 322 descends on the document bundle and a lifting plate ascends to press the document bundle against the feed roller 323 to enter a preliminary operation for document feeding. With a motor (not illustrated) as a driving source, the feed roller 323 and the pickup roller 322 then rotate clockwise to convey the document. The second and subsequent sheets that are about to be conveyed subsequent to the topmost sheet are stopped by a friction piece (not illustrated) and remain on the document stacking unit 340. The separation of the document is detected by a separation sensor (not illustrated) arranged downstream from the feed roller 323.

The separated document then passes between guide plates (not illustrated) and is conveyed to the registration roller pair 324. When the leading edge of the document reaches the registration roller pair 324, the registration roller pair 324 is at rest. The conveyance by the feed roller 323 loops the document to correct skew, and the document is conveyed to a document conveyance unit 342.

The document conveyance unit 342 rotates a conveyance belt 325 which is stretched between a driving roller 326 and a driven roller 327. The conveyance belt 325 is pressed against the platen glass 302 by pressure rolls 328. The document conveyed to between the conveyance belt 325 and the platen glass 302 passes over the platen glass 302 by frictional force of the conveyance belt 325.

The document conveyed from the document feeding unit 341 to the document conveyance unit 342 is conveyed to a predetermined position of the platen glass 302 by the conveyance belt 325. In response, the driving motor (not illustrated) is stopped to stop conveyance. The image on the document is then read by the scanner unit 130.

After the reading by the scanner unit 130 ends, the document is conveyed to a reversing discharge unit 343 by the conveyance belt 325. Here, a reversing flapper 331 for regulating the traveling path of the sheet near an inlet of the reversing discharge unit 343 is controlled by a solenoid (not illustrated) to convey the document to a reversing roller 329. The document is then nipped between the reversing roller 329 rotating counterclockwise and a reversing roll 332 opposed to the reversing roller 329, and conveyed to a conveyance roller pair 330.

If the trailing edge of the document reaches a point at which the trailing edge of the document passes through a discharge flapper 333, the discharge flapper 333 turns clockwise and the reversing roller 329 makes reverse rotation, i.e., clockwise. This starts switchback conveyance of the document. The document thus conveyed by the clockwise rotation of the reversing roller 329 is discharged to a document discharge unit 344. If there is a subsequent document, the subsequent document is conveyed to the predetermined position by the rotation of the conveyance belt 325 like the preceding document. The image on the document stopped at the reading position by the stop of the driving motor is then read by the scanner unit 130. During the execution of such a scan operation, the preceding document is reversed by the reversing discharge unit 343 which operates independently, and conveyed to the document discharge unit 344.

In the example of FIG. 3B, the ADF reading is described to be performed by conveying the document to the reading position of the pressing plate reading and stopping the conveyance of the document for scanning (referred to as fixed reading). However, this is not restrictive. For example, if the scanner unit 130 includes a reading sensor fixed to the conveyance path of the document, the ADF reading may be performed by executing scanning while conveying the document at constant speed (referred to as feed reading).

In the example of FIG. 3B, to scan the back of the document, the ADF reading is described to be performed by scanning the front of the document, reversing and conveying the document, and then reading the back of the document (referred to as two-sided reversing reading). However, this is not restrictive. For example, if the scanner unit 130 includes two reading sensors above and below the conveyance path of the document, the ADF reading may be performed by simultaneously scanning the front and back of the document during feed reading (referred to as two-sided simultaneous reading).

Next, details of the sheet management table 400 for managing the attribute information about the sheets used for printing in the printing apparatus 100 will be described with reference to FIG. 4.

Examples of the sheets used for printing in the printing apparatus 100 include sheets to be used in a standard manner, sheets evaluated by printer makers, and user-defined sheets which are standard sheets or evaluated sheets of which attribute information is customized by the user. The attribute information about such a plurality of sheets is stored in the RAM 113 or the HDD 115 in a list form using the sheet management table 400. The pieces of data registered in the sheet management table 400 are digital information such as Extensible Markup Language (XML) and comma-separated values (CSV). Software modules can read and write the sheet management table 400 stored in the RAM 133 or the HDD 115.

Next, details of the data registered in the sheet management table 400 (attribute information about sheets) will be described below.

A sheet name (411) is information for identifying the sheets used for printing from each other.

A sheet length in a sub scanning direction (412), a sheet length in a main scanning direction (413), grammage of a sheet (414), and a surface property of the sheet (415) are physical properties of the sheet used for printing. The surface property of the sheet (415) is an attribute for indicating a physical property of the surface of the sheet. Examples include “coated” which indicates the application of surface coating for improved glossiness, and “embossed” which indicates the presence of surface projections and depressions.

Color of a sheet (416) is an attribute for indicating the background color of the sheet. Preprinted paper (417) is information for identifying whether the sheet used for printing is preprinted paper.

The printing apparatus 100 adjusts a shift in the printing position with respect to a sheet at the time of execution of printing so that an image is printed in an ideal printing position.

The amount of shift in the printing position with respect to the front of a sheet (420) is information indicating the amounts of positional shift from an ideal printing position on the front of the sheet. The amount of shift in the printing position with respect to the back of a sheet (421) is information indicating the amounts of positional shift from an ideal printing position on the back of the sheet.

Examples of the amounts of shift in the printing position (420 and 421) include the amount of shift in the printing position in the sub scanning direction (hereinafter, referred to as the amount of shift in a lead position) with respect to the sheet. The lead position refers to the start position of printing of an image, with the leading edge of the sheet in the conveyance direction of the sheet as the origin. An initial value of the lead position is zero. To adjust the amount of shift in the lead position, the start timing of irradiation of the laser beam with which the image exposure device 223 irradiates the photosensitive drum 153 is adjusted. As a result, the start position of printing of the image with respect to the leading edge of the sheet in the conveyance direction of the sheet is changed.

Examples of the amounts of shift in the printing position (420 and 421) include the amount of shift in the printing position in the main scanning direction (hereinafter, referred to as the amount of shift in a side position) with respect to the sheet. The side position refers to the start position of printing of an image, with the left edge of the sheet in the conveyance direction of the sheet as the origin. An initial value of the side position is zero. To adjust the amount of shift in the side position, the start timing of irradiation of the laser light with which the image exposure device 223 irradiates the photosensitive drum 153 is adjusted. As a result, the start position of printing of the image with respect to the left edge of the sheet in the conveyance direction of the sheet is changed.

Examples of the amounts of shift in the printing position (420 and 421) include the amount of shift in an image length (magnification to an identical length) in the sub scanning direction (hereinafter, referred to as sub scanning magnification) and the amount of shift in an image length (magnification to an identical length) in the main scanning direction (hereinafter, referred to as main scanning magnification). Initial values of the sub scanning magnification and the main scanning magnification are zero. The sub scanning magnification is adjusted by controlling a driving speed of the transfer belt 154. The main scanning magnification is adjusted by controlling a clock frequency of the laser beam when the image exposure device 223 modulates the digital image signal into the laser beam.

The amounts of shift in the printing position (420 and 421) are calculated by the scanner unit 130 scanning an adjustment chart on which predetermined marks are printed, and detecting the positions of the marks on the adjustment chart. The amounts of shift in the printing position (420 and 421) may be obtained from the PC 101. The operation unit 120 may receive inputs from the user to obtain the amounts of shift in the printing position (420 and 421).

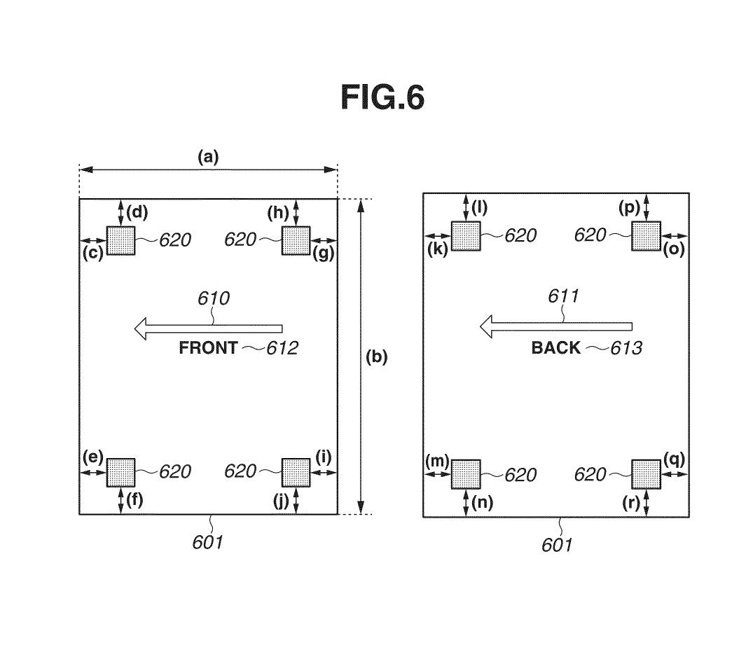

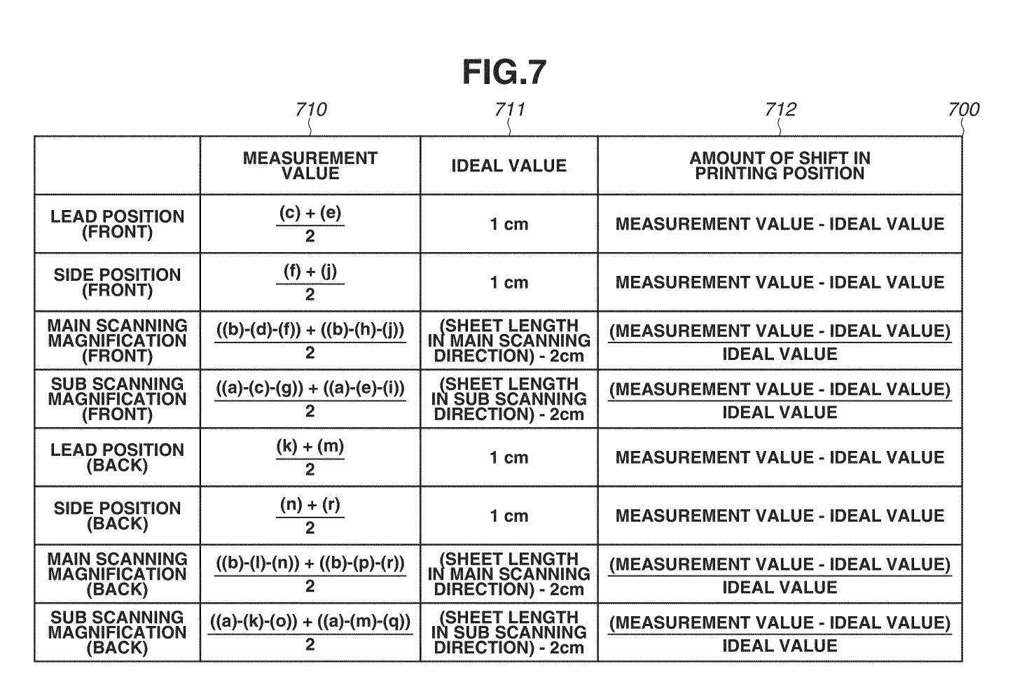

The adjustment chart on which predetermined marks are printed will be described in detail below with reference to FIG. 6. A method for detecting the positions of the marks on the adjustment chart will be described in detail below with reference to FIG. 7.

In the foregoing description, the amounts of shift in the printing position (420 and 421) are described to be adjusted, for example, by adjusting the irradiation timing of the laser beam. However, this is not restrictive. A shift in the printing position may be adjusted by shifting the image to be printed on the sheet itself by a predetermined amount during printing. When adjusting the amounts of shift in the printing position, the user may be allowed to arbitrarily specify the amounts of shift of the image to be printed on the sheet.

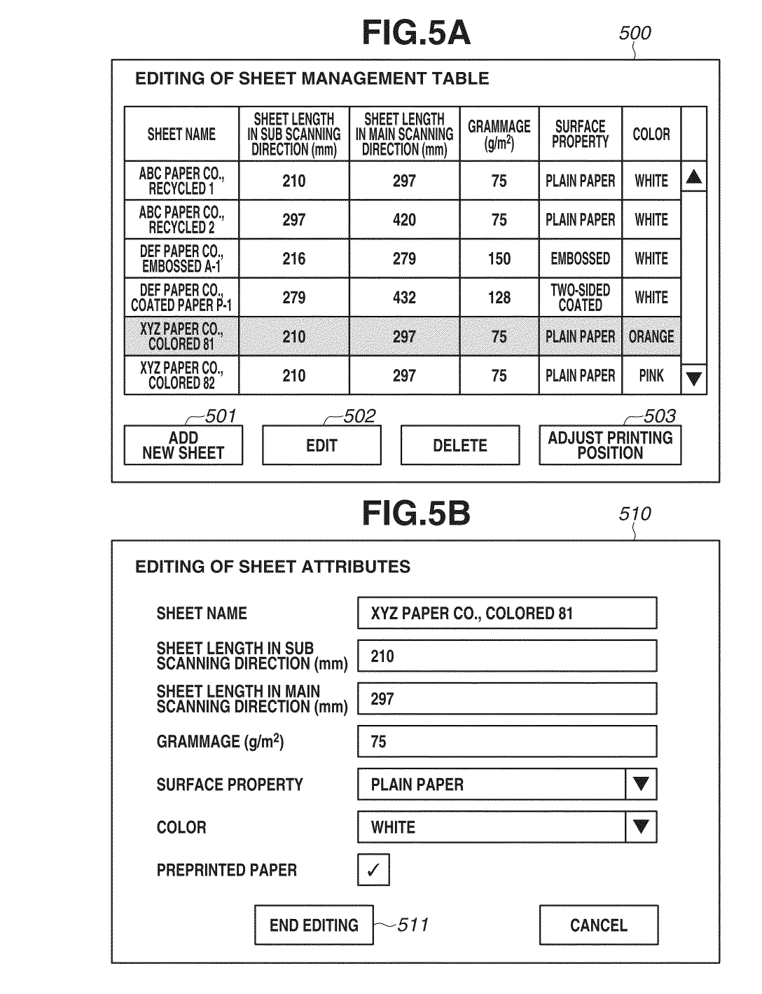

The user can edit the attribute information about the sheets registered in the sheet management table 400 and additionally register a new sheet into the sheet management table 400 by using an editing screen 500 illustrated in FIG. 5A. For example, the editing screen 500 is displayed on the display unit of the operation unit 120 or a monitor (not illustrated) of the PC 101.

A sheet selected by the user on the editing screen 500 is highlighted. In the example of FIG. 5A, the sheet “XYZ paper co., colored 81” is highlighted.

The user can press a button 501 on the editing screen 500 to add a new sheet to be registered in the sheet management table 400. The user can press a button 502 on the editing screen 500 to edit the attribute information about the selected sheet (highlighted sheet). If the button 501 or 502 is pressed by the user, an editing screen 510 illustrated in FIG. 5B is called. For example, the editing screen 510 is displayed on the display unit of the operation unit 120 or the monitor (not illustrated) of the PC 101.

On the editing screen 510, the user can input respective pieces of data about, for example, the sheet name, sheet length in the sub scanning direction, sheet length in the main scanning direction, grammage, surface property, color, and preprinted paper. The surface property is selected from a list of surface properties that can be supported by the printing apparatus 100. The color is selected from a list of colors registered in advance. If the user inputs the pieces of data and then presses a button 511 on the editing screen 510, the data (attribute information about the sheet) input at that point in time is finalized and registered in the sheet management table 400.

On the editing screen 500, the user can input attribute information about the sheet name, sheet length in the sub scanning direction, sheet length in the main scanning direction, grammage, surface property, and color. With regard to the surface property, the user selects one from the list of surface properties that can be supported by the printing apparatus 100. With regard to the color, the user can select arbitrary one from the list of colors registered in advance. On the editing screen 510, the user can input information about whether the sheet to edit is preprinted paper.

If the user presses an editing end button 511 on the editing screen 510, the sheet attributes inputted at that point in time are finalized and registered in the sheet management table 400.

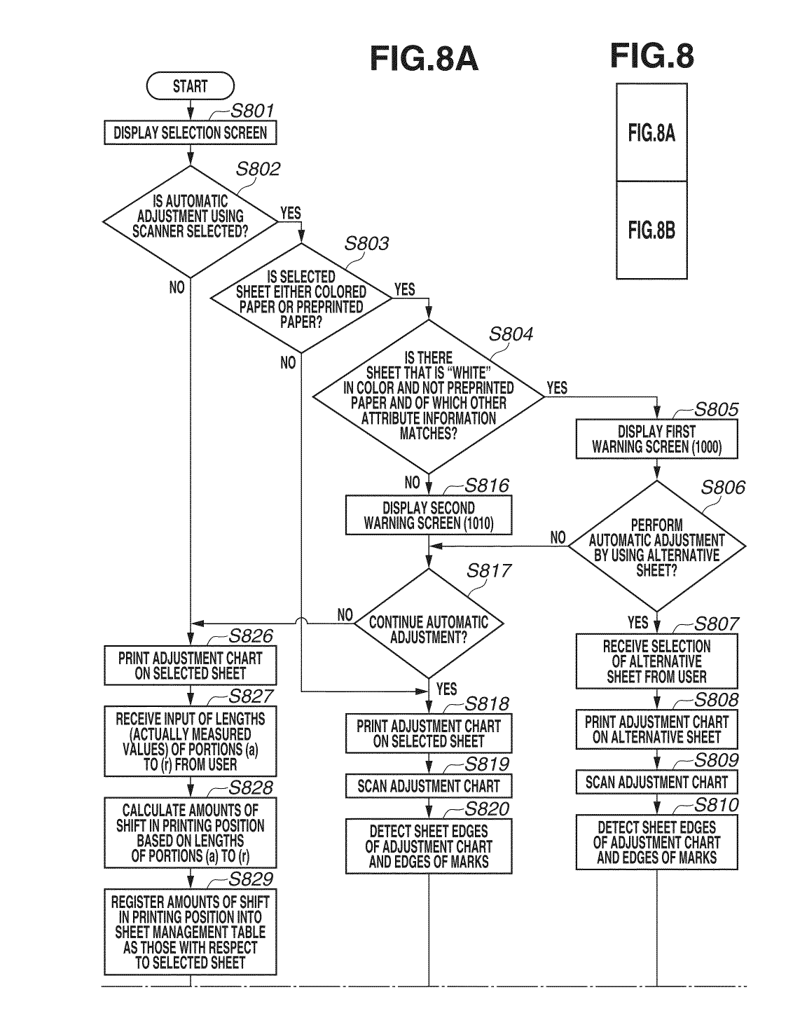

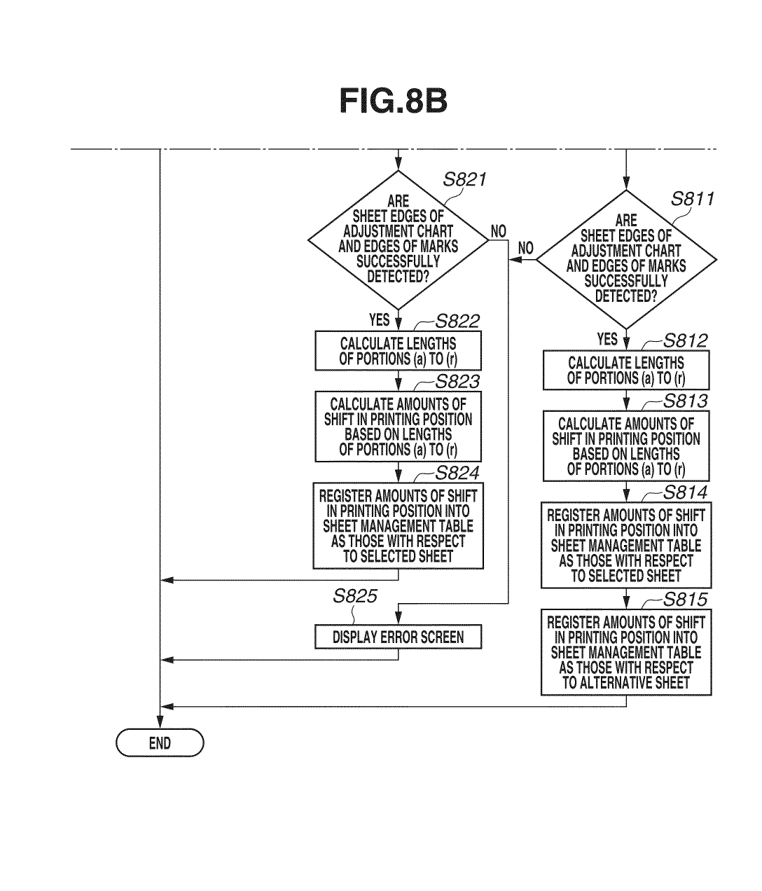

The user can press a button 503 on the editing screen 500 to perform a series of processing for adjusting the printing position with respect to the selected sheet (highlighted sheet). Details of the series of processing for adjusting the printing position will be described below with reference to FIGS. 8A and 8B.

Next, an example of a schematic diagram illustrating an adjustment chart used to adjust the printing position will be described with reference to FIG. 6.

To adjust the printing position on the front of a sheet, marks 620 are printed in specific positions (for example, on four corners) of the front of the sheet. To adjust the printing position on the back of the sheet, marks 620 are printed in specific positions (for example, on four corners) of the back of the sheet.

In the present exemplary embodiment, the printing position is adjusted by using a sheet (for example, adjustment chart 601) on which four marks 620 are printed on the front and four on the back (i.e., a total of eight marks 620 on both sides).

The marks 620 are formed by using toner of color between which and a normal sheet a large difference in reflectance exists. An example of the toner of color between which and a normal sheet a large difference in reflectance exists is black toner.

An image 610 for identifying the conveyance direction of the adjustment chart 601 and an image 612 for identifying the front or back of the adjustment chart 601 are printed on the front of the adjustment chart 601. An image 611 for identifying the conveyance direction of the adjustment chart 601 and an image 613 for identifying the front or back of the adjustment chart 601 are printed on the back of the adjustment chart 601.

That is, to position two-sided images when performing two-sided print processing, the images 610 and 612 are printed on the front of the adjustment chart 601, and the images 611 and 613 are printed on the back of the adjustment chart 601. To adjust the printing position when performing one-sided print processing, at least the images 610 and 612 are printed on the front of the adjustment chart 601.

The images 610 and 611 for identifying the conveyance direction of the adjustment chart 601 have only to be printed if the adjustment chart 601 is scanned by ADF reading. If the adjustment chart 601 is scanned by pressing plate reading, the images 610 and 611 do not need to be printed.

As illustrated in FIG. 6, examples of the images 610 and 611 are arrows from which the user can identify the conveyance direction. Examples of the images 612 and 613 are characters from which the user can identify the front and back.

The image data on the adjustment chart 601 is stored in the RAM 113 or the HDD 115. When printing the adjustment chart 601, the image data on the adjustment chart 601 is read from the RAM 113 or HDD 115 and transferred to the printer engine 150.

The marks 620 are arranged to, if printed in ideal positions, be printed in positions at predetermined distances from the edges of the sheet. The positions of the marks 620 printed on the front of the adjustment chart 601 are then measured to calculate the amounts of shift in the printing position on the front of the sheet. The positions of the marks 620 printed on the back of the adjustment chart 601 are measured to calculate the amounts of shift in the printing position on the back of the sheet.

Relative positions between the respective marks 620 printed on the front and back of the adjustment chart 601 may be measured to calculate the amounts of shift in the printing position on the back of the sheet relative to the printing position on the front, or the amounts of shift in the printing position on the front of the sheet relative to the printing position on the back.

In the present exemplary embodiment, for example, portions (a) to (j) on the front of the adjustment chart 601 and portions (k) to (r) on the back of the adjustment chart 601 are measured to measure the positions of the respective marks 620. The portion (a) is the length of the adjustment chart 601 in the sub scanning direction. The portion (b) is the length of the adjustment chart 601 in the main scanning direction. The ideal length of the portion (a) is the sheet length in the sub scanning direction (412) registered in the sheet management table 400. The ideal length of the portion (b) is the sheet length in the main scanning direction (413) registered in the sheet management table 400. The lengths of the portions (c) to (r) are the distances from the respective marks 620 to closest sheet edges.

The lengths of the portions (a) to (r) may be measured by a manual measurement method or an automatic calculation method. In the manual measurement method, the user actually measures the lengths of the portions (a) to (r) of the adjustment chart 601 by using a ruler.

In the automatic calculation method, the scanner unit 130 scans the adjustment chart 601. The CPU 114 then analyzes the image data generated by reading the images of the adjustment chart 601. From the analysis result, the CPU 114 detects sheet edges of the adjustment chart 601 and edges of the marks 620 (i.e., the borders between the background of the adjustment chart 601 and the marks 620) based on a difference in density. The CPU 114 then calculates the lengths of the portions (a) to (r) from the detected sheet edges and edges of the marks 620.

Next, a method for calculating the amounts of shift in the printing position based on the measured positions of the marks 620 will be described with reference to FIG. 7.

FIG. 7 illustrates a table 700 which defines measurement values (710), ideal values (711), and the amounts of shift in the printing position (712) of the “lead position,” “side position,” “main scanning magnification,” and “sub scanning magnification” on the front and back of the adjustment chart 601. The table 700 is stored in the RAM 113 or the HDD 115.

For example, the measurement value (710) of the “lead position” on the front of the adjustment chart 601 is calculated from the actually measured values of the portions (c) and (e) illustrated in FIG. 6 by using the formula illustrated in the table 700. More specifically, the lead position is an average of the distances from the leading edge of the sheet in the conveyance direction of the sheet to the corresponding marks 620.

For example, the measurement value (710) of the “side position” on the front of the adjustment chart 601 is calculated from the actually measured values of the portions (f) and (j) illustrated in FIG. 6 by using the formula illustrated in the table 700. More specifically, the side position is an average of the distances from the left edge of the sheet in the conveyance direction of the sheet to the corresponding marks 620.

For example, the measurement value (710) of the “main scanning magnification” on the front of the adjustment chart 601 is calculated from the actually measured values of the portions (b), (d), (f), (h), and (j) illustrated in FIG. 6 by using the formula illustrated in the table 700. More specifically, the main scanning magnification is an average of the distances between the marks 620 arranged on the same scanning lines in the main scanning direction.

For example, the measurement value (710) of the “sub scanning magnification” on the front of the adjustment chart 601 is calculated from the actually measured values of the portions (a), (c), (e), (g), and (i) illustrated in FIG. 6 by using the formula illustrated in the table 700. More specifically, the sub scanning magnification is an average of the distances between the marks 620 arranged on the same scanning lines in the sub scanning direction.

As illustrated in the table 700, the ideal values (711) of the “lead position” and the “side position” are both 1 cm. In other words, the marks 620 can ideally be printed in positions separated by 1 cm from the respective corresponding sheet edges.

As illustrated in the table 700, the ideal value (711) of the “main scanning magnification” is a value obtained by subtracting 2 cm from the sheet length in the main scanning direction of each sheet registered in the sheet management table 400. Similarly, the ideal value (711) of the “sub scanning magnification” is a value obtained by subtracting 2 cm from the sheet length in the sub scanning direction of each sheet registered in the sheet management table 400.

As illustrated in the table 700, the amounts of shift in the printing position (712) in terms of the “lead position,” “side position,” “main scanning magnification,” and “sub scanning magnification” are calculated by using the respective corresponding measurement values (710) and ideal values (711). More specifically, the amounts of shift in the printing position (712) of the “lead position” and the “side position” are calculated by subtracting the ideal values (711) from the measurement values (710) (in units of “mm”). The amounts of shift in the printing position (712) of the “main scanning magnification” and the “sub scanning magnification” are calculated by subtracting the ideal values (711) from the measurement values (710), and dividing the subtracted resultant by the ideal values (711) (in units of “%”).

The amounts of shift in the printing position (712) calculated above are registered in the sheet management table 400 as the attribute information about the sheet.

As described above, the method for automatically calculating the lengths of the portions (a) to (r) includes scanning the adjustment chart 601 by the scanner unit 130. The CPU 114 then analyzes the image data generated by reading the images of the adjustment chart 601. From the analysis result, the CPU 114 detects the sheet edges of the adjustment chart 601 and the edges of the marks 620 (i.e., the borders between the background of the adjustment chart 601 and the marks 620) based on a difference in density. The CPU 114 then calculates the lengths of the portions (a) to (r) from the detected sheet edges and edges of the marks 620.

The method for automatically calculating the lengths of the portions (a) to (r) by scanning the adjustment chart 601 uses a difference in density between the background of the sheet on which the adjustment chart 601 is printed and the marks 620. If the background of the sheet on which the adjustment chart 601 is printed is colored paper and the difference in density between the background of the sheet and the marks 620 is small, the edges of the marks 620 may be unable to be correctly detected. If the sheet on which the adjustment chart 601 is printed is preprinted paper and the image preprinted on the sheet overlaps with the marks 620, the edges of the marks 620 may be unable to be correctly detected.

In the exemplary embodiment described above, the method for automatically calculating the lengths of the portions (a) to (r) by scanning the adjustment chart 601 uses a difference in density between the background of the sheet on which the adjustment chart 601 is printed and the marks 620. Suppose that the scanner unit 130 in use has a low sensitivity. If the background of the sheet on which the adjustment chart 601 is printed is colored paper and the difference in density between the background of the sheet and the marks 620 is small, the scanner unit 130 may fail to correctly detect the edges of the marks 620. Moreover, if the sheet on which the adjustment chart 601 is printed is preprinted paper and the image preprinted on the sheet overlaps with the marks 620, the scanner unit 130 may fail to correctly detect the edges of the marks 620. In view of the foregoing, an exemplary embodiment that can accommodate the case of using a low-sensitivity scanner unit 130 will be described below. Note that the present invention is not limited to the exemplary embodiment described below. For example, the exemplary embodiment described below may only use the method for automatically calculating the lengths of the portions (a) to (r) by scanning the adjustment chart 601. In other words, an exemplary embodiment not using an alternative sheet is also covered by the present invention.

In the first exemplary embodiment, for example, when adjusting a shift in the printing position with respect to colored paper, the CPU 114 instructs the image forming unit 151 to print the adjustment chart 601 on an alternative sheet (for example, white paper) based on the attribute information about the colored paper. The CPU 114 then instructs the scanner unit 130 to scan the adjustment chart 601. The CPU 114 then calculates the amounts of shift in the printing position with respect to the alternative sheet, based the scan image date of the adjustment chart 601 printed on the alternative sheet, and registers the amounts of shift in the printing position as those with respect to the colored paper.

A detailed description will be given below.

A series of processing by which the printing apparatus 100 according to the first exemplary embodiment adjusts the printing position will be described with reference to the flowchart illustrated in FIGS. 8A and 8B. Such processing is performed by the CPU 114 of the controller unit 110 executing a control program that is read from the ROM 112 or the HDD 155 and loaded into the RAM 113. The processing is started, for example, if the editing screen 500 is displayed on the display unit of the operation unit 120 and the user presses the button 503 to adjust the printing position with an arbitrary sheet selected on the editing screen 500.

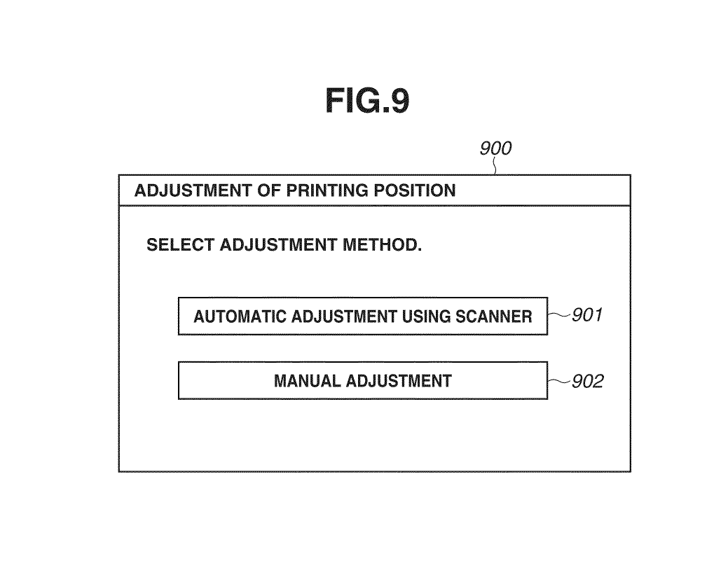

In step S801, the CPU 114 displays a selection screen 900 illustrated in FIG. 9 on the display unit of the operation unit 120. The processing proceeds to step S802. The selection screen 900 is a screen for making the user select either “automatic adjustment using the scanner” or “manual adjustment” as a method for adjusting the printing position.

In step S802, the CPU 114 determines whether “automatic adjustment using the scanner” is selected. If the user presses a button 901 on the selection screen 900, the CPU 114 determines it to be yes (YES in step S802), and the processing proceeds to step S803. If the user presses a button 902 on the selection screen 900, the CPU 114 determines it to be no (NO in step S802), and the processing proceeds to step S826.

In step S803, the CPU 114 determines whether the sheet selected on the editing screen 500 is “colored paper” or “preprinted paper.” The CPU 114 can determine whether the selected sheet is “colored paper”, by referring to the attribute data on the color (416) of the sheet registered in the sheet management table 400. The CPU 114 can determine whether the selected sheet is “preprinted paper”, by referring to the attribute data on the preprinted paper (417) of the sheet registered in the sheet management table 400.

If the CPU 114 determines that the selected sheet is either “colored paper” or “preprinted paper” (YES in step S803), the processing proceeds to step S804. If the CPU 114 determines that the selected sheet is neither “colored paper” nor “preprinted paper” (NO in step S803), the processing proceeds to step S818.

In step S804, the CPU 114 searches the sheets registered in the sheet management table 400 for a sheet which is “white” in color and not preprinted paper and of which the other attribute information (including the sheet lengths, grammage, and surface property) matches that of the selected sheet. As a result of search in step S804, if the CPU 114 determines that there is at least one sheet corresponding to such conditions (YES in step S804), the processing proceeds to step S805. If the CPU 114 determines it to be no (NO in step S804), the processing proceeds to step S816.

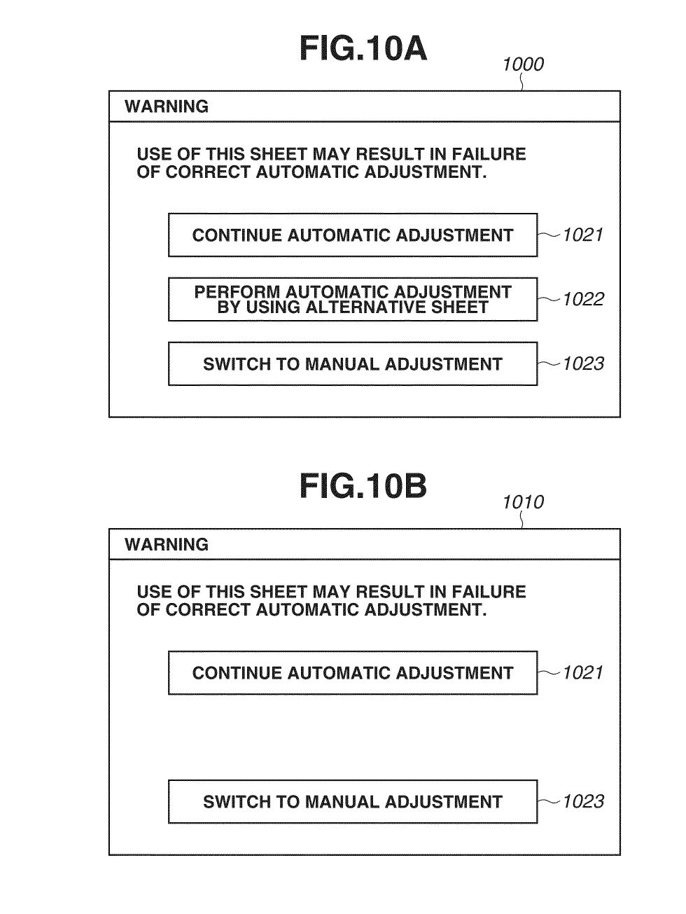

In step S805, the CPU 114 displays a warning screen 1000 (referred to as a first warning screen) illustrated in FIG. 10A on the display unit of the operation unit 120. The processing proceeds to step S806. The warning screen 1000 is a screen for notifying the user of the possibility that the automatic adjustment of the printing position may be unable to be correctly performed. The warning screen 1000 also serves as a screen for receiving the user's instruction about whether to automatically calculate the lengths of the portions (a) to (r) of the adjustment chart 601 illustrated in FIG. 6, manually measure the lengths, or print the adjustment chart 601 on an alternative sheet for automatic calculation.

In step S806, the CPU 114 determines whether to perform automatic adjustment by using an alternative sheet. If the user presses a button 1022 on the warning screen 1000, the CPU 114 determines it to be yes (YES in step S806), and the processing proceeds to step S807. If the user presses a button 1021 or 1023 on the warning screen 1000, the CPU 114 determines it to be no (NO in step S806), and the processing proceeds to step S817.

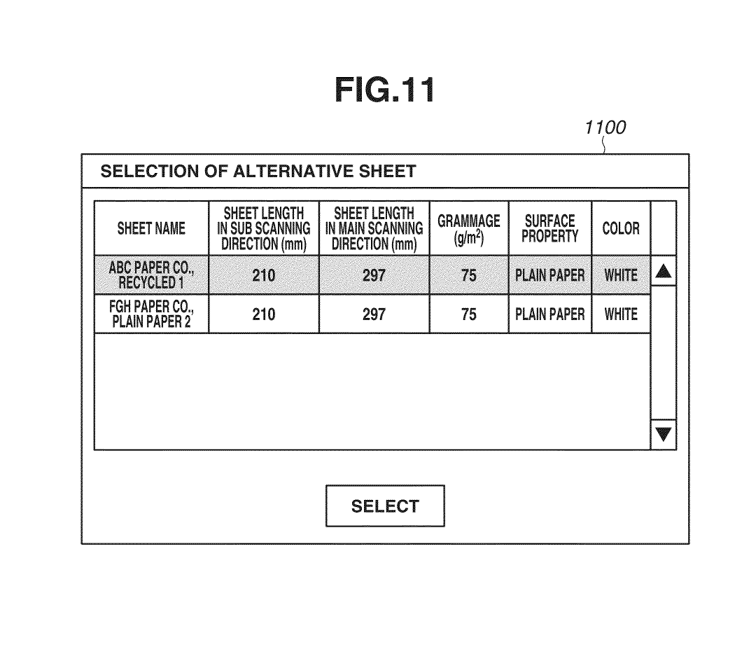

In step S807, the CPU 114 receives selection of an alternative sheet for the automatic adjustment of the printing position from the user on a selection screen 1100 illustrated in FIG. 11, displayed on the display unit of the operation unit 120. The processing proceeds to step S808. The selection screen 1100 displays a sheet or sheets which is/are “white” in color and not preprinted paper and of which the other attribute information (such as the sheet lengths, grammage, and surface property) matches that of the selected sheet, among the sheets registered in the sheet management table 400, as a candidate or candidates.

In step S808, the CPU 114 instructs the image forming unit 151 to print the adjustment chart 601 illustrated in FIG. 6 on the alternative sheet selected in step S807. Here, the image data on the adjustment chart 601 is read from the RAM 113 or the HDD 115 and transferred to the printer engine 150. Receiving the print instruction, the image forming unit 151 prints the adjustment chart 601 on the alternative sheet fed from the feeding unit 140 based on the transferred image data. The sheet on which the adjustment chart 601 is printed is discharged from the printing apparatus 100. The user then places the sheet discharged from the printing apparatus 100 (the sheet on which the adjustment chart 601 is printed) on the platen glass 302.

In step S809, the CPU 114 instructs the scanner unit 130 to scan the adjustment chart 601 printed in step S808. The processing proceeds to step S810. The CPU 114 gives the scan instruction, for example, if the user presses the start key for instructing the start of execution of scanning.

In step S810, the CPU 114 performs image analysis on image data generated by scanning the adjustment chart 601. Based on the image analysis, the CPU 114 then detects the sheet edges of the adjustment chart 601 and the edges of the marks 620 (i.e., the borders between the background of the adjustment chart 601 and the marks 620), focusing on a difference in density. The processing proceeds to step S811.

In step S811, the CPU 114 determines whether the sheet edges of the adjustment chart 601 and the edges of the marks 620 are successfully detected as a result of the detection processing in step S810. If the CPU 114 determines that the edges are successfully detected (YES in step S811), the processing proceeds to step S812. If the CPU 114 determines it to be no (NO in step S811), the processing proceeds to step S825. In step S811, the CPU 114 determines it to be no if, for example, the difference in density between the background of the sheet on which the adjustment chart 601 is printed and the marks 620 is small and the edges of the marks 620 are not able to be correctly detected.

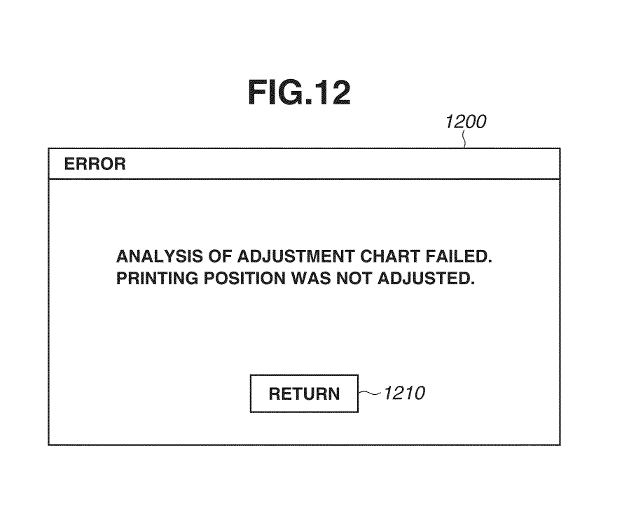

In step S825, the CPU 114 displays an error screen 1200 illustrated in FIG. 12 on the display unit of the operation unit 120. The error screen 1200 is a screen for notifying the user that the CPU 114 has failed in the image analysis of the adjustment chart 601 and the printing position has not been adjusted. After the processing of step S825, the series of processing related to FIGS. 8A and 8B ends.

Now, return to the description of the processing of step S812 and subsequent steps.

In step S812, the CPU 114 calculates the lengths of the portions (a) to (r) illustrated in FIG. 6 from the detected sheet edges and edges of the marks 620. The processing proceeds to step S813.

In step S813, the CPU 114 calculates the amounts of shift in the printing position (712) based on the lengths of the portions (a) to (r) calculated in step S812. The processing proceeds to step S814. The amounts of shift in the printing position (712) are calculated by using the formulas described above with reference to FIG. 7.

In step S814, the CPU 114 registers the amounts of shift in the printing position (712) into the sheet management table 400 as those with respect to the sheet selected on the editing screen 500. For example, in step S814, the lead positions, side positions, main scanning magnifications, and sub scanning magnifications are registered as information indicating the amounts of shift in the printing position on the front (420) and the amounts of shift in the printing position on the back (421) with respect to the selected sheet. The processing then proceeds to step S815. In step S815, the CPU 114 registers the amounts of shift in the printing position (712) into the sheet management table 400 as those with respect to the alternative sheet selected in step S807. For example, in step S815, the lead positions, side positions, main scanning magnifications, and sub scanning magnifications are registered as information indicating the amounts of shift in the printing position on the front (420) and the amounts of shift in the printing position on the back (421) with respect to the alternative sheet. After the processing of step S815, the series of processing related to FIGS. 8A and 8B ends.

In step S816, the CPU 114 displays a warning screen 1010 (referred to as a second warning screen) illustrated in FIG. 10B on the display unit of the operation unit 120. The processing proceeds to step S817. The warning screen 1010 is a screen for notifying the user of the possibility that the automatic adjustment of the printing position may be unable to be correctly performed. The warning screen 1010 also serves as a screen for receiving the user's instruction about whether to automatically calculate or manually measure the lengths of the portions (a) to (r) of the adjustment chart 601 illustrated in FIG. 6.

In step S817, the CPU 114 determines whether to continue the automatic adjustment. If the user presses the button 1021 on the warning screen 1000 or 1010, the CPU 114 determines it to be yes (YES in step S817), and the processing proceeds to step S818. If the user presses the button 1023 on the warning screen 1000 or 1010, the CPU 114 determines it to be no (NO in step S817), and the processing proceeds to step S826.

In step S818, the CPU 114 instructs the image forming unit 151 to print the adjustment chart 601 illustrated in FIG. 6 on the sheet selected on the editing screen 500. Here, the image data on the adjustment chart 601 is read from the RAM 113 or the HDD 115 and transferred to the printer engine 150. Receiving the print instruction, the image forming unit 115 prints the adjustment chart 601 on the selected sheet fed from the feeding unit 140 based on the transferred image data. The sheet on which the adjustment chart 601 is printed is discharged from the printing apparatus 100. The user then places the sheet discharged from the printing apparatus 100 (the sheet on which the adjustment chart 601 is printed) on the platen glass 302.

In step S819, the CPU 114 instructs the scanner unit 130 to scan the adjustment chart 601 printed in step S818. The processing proceeds to step S820. The CPU 114 gives the scan instruction, for example, if the user presses the start key for instructing the start of execution of scanning.

In step S820, the CPU 114 performs image analysis on image data generated by scanning the adjustment chart 601. Based on the image analysis, the CPU 114 detects the sheet edges of the adjustment chart 601 and the edges of the marks 620 (i.e., the borders between the background of the adjustment chart 601 and the marks 620), focusing on a difference in density. The processing proceeds to step S821.

In step S821, the CPU 114 determines whether the sheet edges of the adjustment chart 601 and the edge of the marks 620 are successfully detected as a result of the detection processing in step S820. If the CPU 114 determines that the edges are successfully detected (YES in step S821), the processing proceeds to step S822. If the CPU 114 determines it to be no (NO in step S821), the processing proceeds to step S825.

In step S821, the CPU 114 determines it to be no if, for example, the difference in density between the background of the sheet on which the adjustment chart 601 is printed and the marks 620 is small and the edges of the marks 620 are not able to be correctly detected. The CPU 114 may also determine it to be no if the sheet on which the adjustment chart 601 is printed is preprinted paper and the positions of the marks 620 fail to be correctly detected because of overlap between the image preprinted on the sheet and the marks 620.

In step S822, the CPU 114 calculates the lengths of the portions (a) to (r) illustrated in FIG. 6 based on the detected sheet edges and edges of the marks 620. The processing proceeds to step S823.

In step S823, the CPU 114 calculates the amounts of shift in the printing position (712) based on the lengths of the portions (a) to (r) calculated in step S822. The processing proceeds to step S824. The amounts of shift in the printing position (712) are calculated by using the formulas described above with reference to FIG. 7.

In step S824, the CPU 114 registers the amounts of shift in the printing position (712) into the sheet management table 400 as those with respect to the sheet selected on the editing screen 500. For example, in step S824, the lead positions, side positions, main scanning magnifications, and sub scanning magnifications are registered as information indicating the amounts of shift in the printing position on the front (420) and the amounts of shift in the printing position on the back (421) with respect to the selected sheet. After the processing of step S824, the series of processing related to FIGS. 8A and 8B ends.

In step S825, the CPU 114 displays the foregoing error screen 1200 on the display unit of the operation unit 120. After the processing of step S825, the series of processing related to FIGS. 8A and 8B ends.

In step S826, the CPU 114 instructs the image forming unit 151 to print the adjustment chart 601 illustrated in FIG. 6 on the sheet selected on the editing screen 500. Receiving the print instruction, the image forming unit 151 prints the adjustment chart 601 on the selected sheet fed from the feeding unit 140. The sheet on which the adjustment chart 601 is printed is discharged from the printing apparatus 100.

In step S827, the CPU 114 receives input of the manually measured lengths (actually measured values) of the portions (a) to (r) from the user on the editing screen 510. The processing proceeds to step S828.

In step S828, the CPU 114 calculates the amounts of shift in the printing position (712) based on the lengths of the portions (a) to (r) input in step S827. The processing proceeds to step S829. The amounts of shift in the printing position (712) are calculated by using the formulas described above with reference to FIG. 7.

In step S829, the CPU 114 registers the amounts of shift in the printing position (712) into the sheet management table 400 as those with respect to the sheet selected on the editing screen 500. For example, in step S829, the lead positions, side positions, main scanning magnifications, and sub scanning magnifications are registered as information indicating the amounts of shift in the printing position on the front (420) and the amounts of shift in the printing position on the back (421) with respect to the selected sheet. After the processing of step S829, the series of processing related to FIGS. 8A and 8B ends.

That is the details of the series of processing by which the printing apparatus 100 according to the first exemplary embodiment adjusts the printing position.

The CPU 114 is described to register the amounts of shift in the printing position (712) calculated in the processing of step S813 into the sheet management table 400 with respect to both the sheet selected on the editing screen 500 and the alternative sheet selected in step S807. However, this is not restrictive. In an exemplary embodiment, the CPU 114 may register the amounts of shift in the printing position (712) calculated in the processing of step S813 into the sheet management table 400 with respect to the sheet selected on the editing screen 500 and may not register the amounts of shift in the printing position (712) calculated in the processing of step S813 into the sheet management table 400 with respect to the alternative sheet.

As described above, in the first exemplary embodiment, for example, when adjusting a shift in the printing position with respect to colored paper, the CPU 114 instructs the image forming unit 151 to print the adjustment chart 601 on an alternative sheet (for example, white paper) based on the attribute information about the colored paper. The CPU 114 then instructs the scanner unit 130 to scan the adjustment chart 601. The CPU 114 calculates the amounts of shift in the printing position with respect to the alternative sheet based on the scan image data on the adjustment chart 601 printed on the alternative sheet, and registers the amounts of shift in the printing position as those with respect to the colored paper.

In such a manner, even if the difference in density between the background of the sheet and the marks 620 is small and the edges of the marks 620 are not able to be correctly detected, the printing position can be adjusted by using a sheet of which the background and the marks 620 have a large difference in density (for example, white paper) as an alternative. When adjusting the printing position with respect to colored paper, this can save the user the trouble of manually measuring and inputting the lengths from the marks 620 to the sheet edges of the printed adjustment chart 601 after the adjustment chart 601 is printed on the colored paper.

If the sheet on which the adjustment chart 601 is printed is preprinted paper, the edges of the marks 620 may fail to be correctly detected because of overlap between the image preprinted on the sheet and the marks 620. Even in such a case, the printing position can be adjusted by using white paper as an alternative. When adjusting the printing position with respect to preprinted paper, this can save the user the trouble of manually measuring and inputting the lengths from the marks 620 to the sheet edges of the printed adjustment chart 601 after the adjustment chart 601 is printed on the preprinted paper.

The foregoing description has dealt with the case of adjusting a shift in the printing position with respect to colored paper or preprinted paper. A similar description applies to the case of adjusting a shift in the printing position with respect to a transparent sheet such as an overhead projector (OHP) sheet or a transparent film.

In the foregoing first exemplary embodiment, the amounts of shift in the printing position (712) calculated from the adjustment chart 601 printed on an alternative sheet are registered into the sheet management table 400 not only with respect to the sheet selected on the editing screen 500 but also with respect to the alternative sheet.

A second exemplary embodiment describes a case where the amounts of shift in the printing position (712) based on the adjustment chart 601 printed on a selected sheet are registered into the sheet management table 400 not only with respect to the selected sheet but also with respect to a sheet or sheets having the same physical properties as the selected sheet.

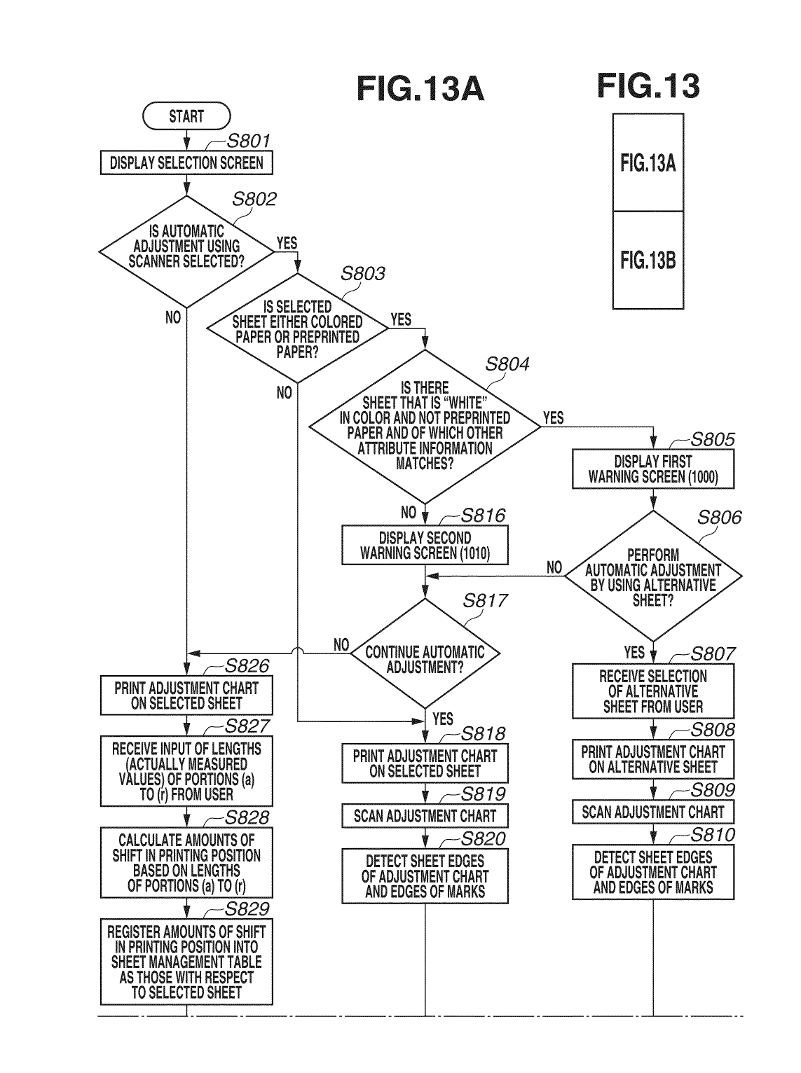

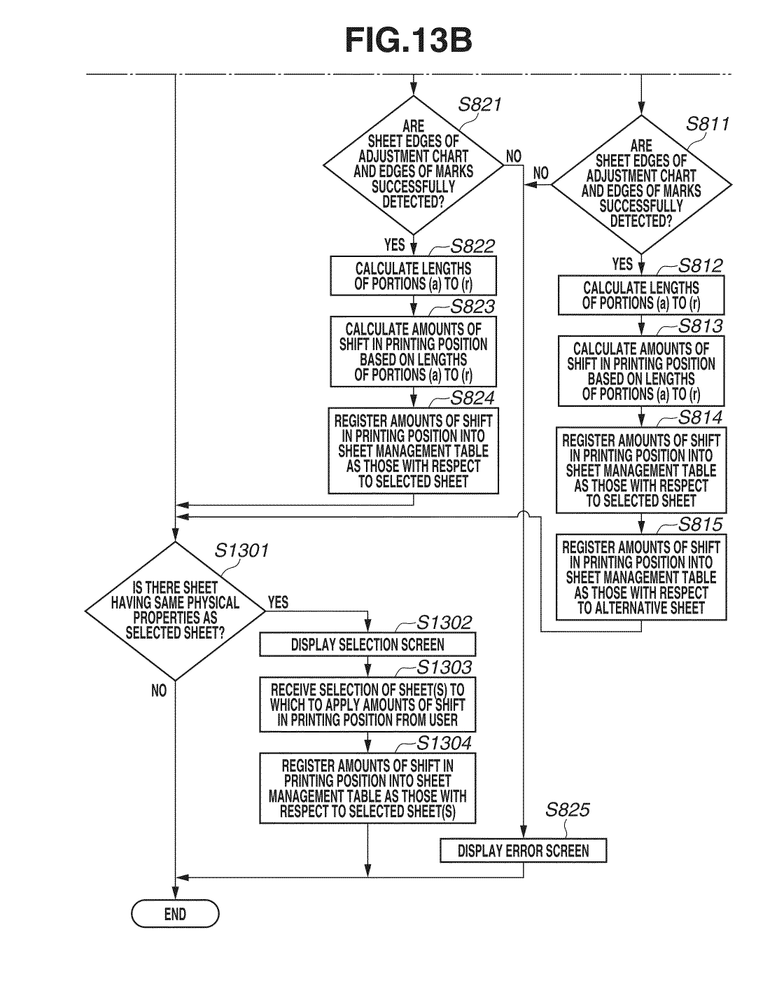

The printing apparatus 100 according to the second exemplary embodiment differs from the first exemplary embodiment in part of the series of processing for adjusting the printing position (control example described above with reference to FIGS. 8A and 8B). Then, the processing different from the first exemplary embodiment will mainly be described with reference to FIGS. 13A and 13B. The processing common to the first exemplary embodiment will be designated by the same step numbers. A detailed description thereof will be omitted.

In FIGS. 13A and 13B, the processing proceeds to step S1301 after the execution of the processing of step S815, S824, or S829.

In step S1301, the CPU 114 determines whether there is a sheet having the same physical properties as the sheet selected on the editing screen 500, among the sheets registered in the sheet management table 400. The CPU 114 can determine whether there is a sheet having the same physical properties as the selected sheet, by referring to the attribute data on the sheet length in the sub scanning direction (412), the sheet length in the main scanning direction (413), the grammage (414), and the surface property (415). As a result of the determination in step S1301, if the CPU 114 determines it to be yes (YES in step S1301), the processing proceeds to step S1302. If the CPU 114 determines it to be no (NO in step S1301), the series of processing related to FIGS. 13A and 13B ends.

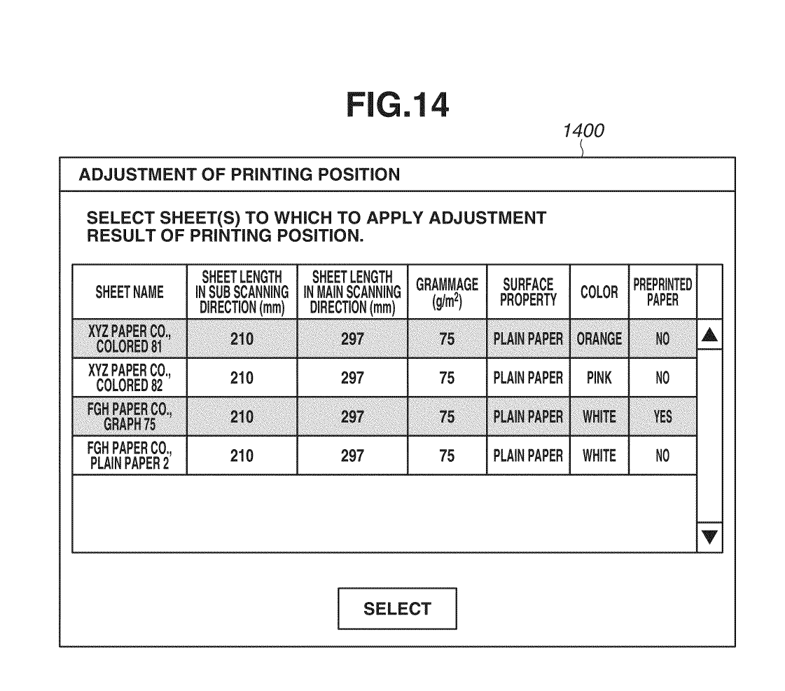

In step S1302, the CPU 114 displays a selection screen 1400 illustrated in FIG. 14 on the display unit of the operation unit 120. The processing proceeds to step S1303. The selection screen 1400 is a screen for notifying the user of a sheet or sheets having the same physical properties as the selected sheet as a candidate or candidates based on the result of the determination in step S1301. The selection screen 1400 also serves as a screen for receiving the user's selection instruction about the sheet(s) to which the amounts of shift in the printing position (712) calculated in step S813, S822, or S828 is to be applied.

In step S1303, the CPU 114 receives selection of the sheet(s) to which the amounts of shift in the printing position (712) calculated in step S813, S822, or S828 is applied, from the user on the selection screen 1400. Note that the user can simultaneously select a plurality of sheets to which the amounts of shift in the printing position (712) is to be applied, on the selection screen 1400. The processing proceeds to step S1304.

In step S1304, the CPU 114 registers the amounts of shift in the printing position (712) into the sheet management table 400 as those with respect to the sheet(s) selected on the selection screen 1400. For example, in step S1304, the lead positions, side positions, main scanning magnifications, and sub scanning magnifications are registered as information indicating the amounts of shift in the printing position on the front (420) and the amounts of shift in the printing position on the back (421) with respect to the selected sheet(s). After the processing of step S1304, the series of processing related to FIGS. 13A and 13B ends.

That is the details of the part of the series of processing by which the printing apparatus 100 according to the second exemplary embodiment adjusts the printing position, the part being different from that of the first exemplary embodiment.

The case has been described where in the processing of step S1301, the CPU 114 determines a sheet or sheets having the same attribute data on the sheet length in the sub scanning direction, the sheet length in the main scanning direction, the grammage, and the surface property, to be the sheet(s) having the same physical properties. However, the present invention is not limited thereto. For example, in an exemplary embodiment, the CPU 114 may determine a sheet or sheets of which part of the attribute data matches part of the attribute data on the sheet length in the sub scanning direction, the sheet length in the main scanning direction, the grammage, and the surface property, to be the sheet(s) having the same physical properties.

As described above, in the second exemplary embodiment, the amounts of shift in the printing position based on the adjustment chat 601 printed on the selected sheet can be registered into the sheet management table 400 not only with respect to the selected sheet but also with respect to a sheet or sheets having the same physical properties as the sheet.

In other words, the processing for adjusting the printing position can be collectively performed on the sheets having the same physical properties among the plurality of sheets registered in the sheet management table 400. This can save the user the trouble of repeating the processing for adjusting the printing position on the sheets having the same physical properties, whereby the user's convenience can be improved.

The present invention is not limited to the foregoing exemplary embodiments. Various modifications (including organic combinations of the exemplary embodiments) may be made based on the gist of the present invention, and such modifications are not intended to be excluded from the scope of the present invention.

For example, in the foregoing exemplary embodiments, the CPU 114 of the controller unit 110 of the printing apparatus 100 serves as the main unit of the foregoing various controls. However, this is not restrictive. A print controlling unit such as an external controller in a housing separate from the printing apparatus 100 may be configured to be able to perform part or all of the foregoing various controls.

In the foregoing exemplary embodiments, the case has been described where the user is places the printed adjustment chart 601 on the platen glass 302 to scan the printed adjustment chart 601 by the scanner unit 130. However, this is not restrictive. A line scanner may be provided on the conveyance path of the sheet so that the line scanner can read the adjustment chart 601 between when the images of the adjustment chart 601 are formed on the sheet and when the sheet is discharged from the printing apparatus 100.

The exemplary embodiments to which the present invention is applied have been described by using the printing apparatus 100 including the image forming unit 151 that handles monochrome toner. However, this is not restrictive. Exemplary embodiments to which the present invention is applied can be similarly described by using a color printing apparatus 100 including an image forming unit 151 that handles toners in a plurality of colors. For example, if a full-color printing apparatus 100 handles four colors cyan (C), magenta (M), yellow (Y), and black (K), the printing apparatus 100 may adjust a printing position by using black toner. The printing positions of the other colors may be adjusted using the printing position of black as a reference.

In the first exemplary embodiment, the case has been described where the user arbitrarily selects the alternative sheet from among the candidates. However, this is not restrictive. For example, in an exemplary embodiment, the CPU 114 may automatically select an alternative sheet based on weighting information such as use frequency. Similarly, in the second exemplary embodiment, the case has been described where the user arbitrarily selects the sheet(s) having the same physical properties from among the candidates. However, this is not restrictive. For example, in an exemplary embodiment, the CPU 114 may automatically select a sheet or sheets having the same physical properties based on weighting information such as use frequency.

While various examples and exemplary embodiments of the present invention have been described above, the gist and scope of the present invention is not limited to the specific descriptions included in this specification document.

### OTHER EMBODIMENTS

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-236996, filed Nov. 21, 2014, which is hereby incorporated by reference herein in its entirety.

What is claimed is:

1. A printing apparatus comprising:
a reading unit configured to read an image to generate image data;
a printing unit configured to print an adjustment image for adjusting a printing position on a first sheet;
an obtaining unit configured to obtain an amount of shift in the printing position based on image data generated by the reading unit reading the adjustment image printed on the first sheet by the printing unit; and
a print controlling unit configured to control the printing unit based on the amount of shift in the printing position obtained by the obtaining unit so that an image is printed on a second sheet of a type different from that of the first sheet.

2. The printing apparatus according to claim 1, wherein the print controlling unit controls the printing unit based on the amount of shift in the printing position obtained by the obtaining unit so that the image is printed on the first sheet.

3. The printing apparatus according to claim 1, further comprising a first setting unit configured to set the amount of shift in the printing position obtained by the obtaining unit for the second sheet,
wherein the print controlling unit controls the printing unit based on the amount of shift in the printing position set by the first setting unit so that the image is printed on the second sheet.

4. The printing apparatus according to claim 1, further comprising a second setting unit configured to set the amount of shift in the printing position obtained by the obtaining unit for the first sheet,
wherein the print controlling unit controls the printing unit based on the amount of shift in the printing position set by the second setting unit so that the image is printed on the first sheet.

5. The printing apparatus according to claim 1, further comprising a determining unit configured to determine the second sheet, attribute information about the second sheet corresponding to attribute information about the first sheet,
wherein the print controlling unit is configured to control the printing unit based on the amount of shift in the printing position obtained by the obtaining unit so that the image is printed on the second sheet determined by the determining unit.

6. The printing apparatus according to claim 5, wherein the attribute information is grammage of the sheet.

7. The printing apparatus according to claim 5, wherein the attribute information is a surface property of the sheet.

8. The printing apparatus according to claim 5, wherein the attribute information is a length of the sheet in a sub scanning direction and a length of the sheet in a main scanning direction.

9. The printing apparatus according to claim 1, further comprising a first receiving unit configured to receive selection of the second sheet from a user,
wherein the print controlling unit is configured to control the printing unit based on the amount of shift in the printing position obtained by the obtaining unit so that the image is printed on the second sheet received from the user by the first receiving unit.

10. The printing apparatus according to claim 1, further comprising a second receiving unit configured to receive selection of the first sheet from a user,
wherein the printing unit prints the adjustment image on the first sheet received from the user by the second receiving unit.

11. The printing apparatus according to claim 1, wherein the second sheet is colored paper, preprinted paper, an OHP sheet, or a transparent film.

12. The printing apparatus according to claim 1, wherein the first sheet is plain paper.

13. A control method in a printing apparatus having a reading unit configured to read an image to generate image data, the control method comprising:
printing, by a printing unit, an adjustment image for adjusting a printing position on a first sheet;
obtaining an amount of shift in the printing position based on image data generated by the reading unit reading the adjustment image printed on the first sheet by the printing unit; and
controlling the printing unit based on the obtained amount of shift in the printing position so that an image is printed on a second sheet of a type different from that of the first sheet.

14. A non-transitory computer readable storage medium for storing a computer program for controlling a printing apparatus having a reading unit configured to read an image to generate image data, the computer program comprising:
a code to print, by a printing unit, an adjustment image for adjusting a printing position on a first sheet;
a code to obtain an amount of shift in the printing position based on image data generated by the reading unit reading the adjustment image printed on the first sheet by the printing unit; and
a code to control the printing unit based on the obtained amount of shift in the printing position so that an image is printed on a second sheet of a type different from that of the first sheet.
